(19) United States
(12) Patent Application Publication
(10) Pub. No.: US 2024/0152818 A1
(43) Pub. Date: May 9, 2024

(54) METHODS FOR MITIGATION OF ALGORITHMIC BIAS DISCRIMINATION, PROXY DISCRIMINATION AND DISPARATE IMPACT

(71) Applicant: SolasAI, Philadelphia, PA (US)

(72) Inventors: NICHOLAS P. SCHMIDT, Philadelphia, PA (US); BERNARD SISKIN, Philadelphia, PA (US); CHRISTOPHER P STOCKS, Philadelphia, PA (US); JAMES L. CURTIS, Philadelphia, PA (US)

(21) Appl. No.: 18/548,054

(22) PCT Filed: Feb. 25, 2022
(86) PCT No.: PCT/US2022/017946

§ 371 Date: Aug. 25, 2023

Related U.S. Application Data
(60) Provisional application No. 63/153,692, filed on Feb. 25, 2021.

(51) Int. Cl. G06N 20/00

(52) U.S. Cl. CPC G06N 20/00

(57) ABSTRACT

A method is provided for debiasing machine learning models. The method includes obtaining (i) an initial model that is a trained and tree-based machine learning model and (ii) a minimum acceptable threshold accuracy, for (iii) one or more protected classes. The initial model demonstrates adverse impact on one or more protected classes. The method includes identifying branches of the initial model to prune, based on the branches' impact on one or more protected classes. The method includes applying a pruning algorithm to prune the branches of the initial model to generate one or more forest models, such that (i) predictive accuracy of the one or more forest models is above the minimum threshold accuracy, and (ii) the one or more forest models are less discriminatory than the initial mode.

### TECHNICAL FIELD

The present disclosure relates to machine learning and, in particular, to systems, methods, and devices for bias mitigation in machine learning models.

### BACKGROUND

Machine learning algorithms have become ubiquitous. Applications of the algorithms touch every aspect of our lives. Computing, in general, and artificial intelligence in particular, provide manifold increases in productivity. At the same time, similar to how people are prone to biases, algorithms that are used for automation are prone to biases and can have an unnecessary disparate and adverse impact to persons in protected classes. These biases can be injected into algorithms in a number of ways. While much of the discussion of bias herein is regarding bias in a legal sense, all of the principles apply to bias in a broader statistical sense. An algorithm demonstrates bias whenever it produces meaningfully different outcomes for different subsets of data—regardless of whether those different outcomes carry legal or ethical ramifications. The debiasing methods discussed herein can be applied regardless of what the subsets of data are and regardless of whether the bias carries legal or ethical consequences.

In many circumstances, it is illegal to explicitly use protected class status or proxies for protected class status in an algorithm, but such use may go undetected because of an algorithm's complexity and opaqueness. More subtly, bias or unfairness in machine learning could arise from biases in training data and/or underlying algorithms. For instance, machine learning models which are not given access to protected classes may still display bias, due to biases in the underlying training data arising from the manner in which the data is collected. Further, even when protected class status or proxies for protected class status are not illegally included in an algorithm and the training data is unbiased, algorithms can still evidence protected class bias. That is, while the algorithm will predict the same outcome for all persons with the same inputs, the accuracy of its predictions may significantly differ for members of a reference group or a control group (e.g., the majority group) and the protected class, to the detriment of the protected class. Moreover, even totally unbiased algorithms may still result in a disparate impact adverse to a protected class or classes, as occurs when an algorithm results in outcomes that are worse for protected class members than non-protected persons. Although such a result from an unbiased algorithm is not necessarily discriminatory, if an alternative algorithm that is similarly predictive but has less disparate impact can be found, the alternative model may be legally or ethically required. Using the algorithm that results in more disparate impact rather than the similarly predictive algorithm with less disparate impact (referred to as the less discriminatory alternative or LDA) would constitute discrimination. In other words, unawareness is not sufficient to ensure lawfully required fairness. Methods for minimizing each of the three problems with algorithms (bias, proxy discrimination, and disparate impact) are often called debiasing methodologies.

Bias, proxy, and/or disparate impact mitigation techniques are broadly classified into: 1) pre-processing techniques that transform training data used to construct machine learning models; 2) in-processing techniques that alter learning algorithms to remove discrimination during training, and; 3) post-processing techniques that are performed after training by using a holdout set. The last of the techniques, post-processing, is especially useful when it is not possible to modify the training data or learning algorithm. For example, prediction labels assigned by a model are reassigned, to make the model less discriminatory. Conventional post-processing techniques, such as pruning, are not parameterizable (e.g., based on user controls or context), and suffer from accuracy issues, when used for bias, proxy, or disparate impact mitigation.

Colloquially, “bias” may refer to discrimination in general. However, there are multiple types of bias in the model fairness context, and a model builder must understand the source of the discrimination or unfairness in a model. Some sources of bias, if identified, can be fixed, and in some cases, legally must be fixed. For example, data bias can be identified when certain populations have more comprehensive data collection than others; label bias occurs in situations where some populations have more accurate label outcomes than others; predictive bias in a model causes predictions for protected class individuals to be less accurate than predictions for reference group individuals; disparate treatment occurs when a model uses a feature that is a statistical proxy for a protected class. In each of these situations, a data scientist would be methodologically introducing bias into a model. On the other hand, a model may generate positive outcomes for protected class members at a lower rate solely because the model is observing real trends in the data, which may be the result of historical discrimination. This is known as disparate impact. In such a situation, it is often still possible to reduce the negative social impact of the model, and it may be necessary to generate alternative models to see if any less discriminatory alternatives are able to satisfy business needs.

### SUMMARY

Accordingly, there is a need for techniques that apply pruning while retaining accuracy. The techniques described herein can be used as a solution for bias, proxy, and/or disparate impact mitigation, provide fine-grain control (e.g., user controls of parameters), and are easily integrated for tree-based models.

According to some implementations, a method is provided for debiasing machine learning models. This method includes obtaining (i) an initial model that is a trained and tree-based machine learning model, (ii) a minimum accuracy threshold, and (iii) one or more protected classes. The initial model demonstrates disparities with respect to the one or more protected classes. In general, protected classes include categories of persons, or classes of individuals that are afforded legal protection against adverse bias or unnecessary disparate impact. Protected classes may include disadvantaged groups. The method also includes identifying branches of the initial model to prune, based on the one or more protected classes. The method also includes applying a pruning algorithm to prune the branches of the initial model to generate at least one forest model, such that (i) the predictive accuracy of the one or more forest model is above the minimum threshold accuracy, and (ii) the one or more forest models are less discriminatory than the initial model.

In some implementations, the method further includes obtaining a maximum number of nodes that can be removed, and so, when identifying branches of the initial model to prune, avoids selecting branches that would remove more than the maximum number of nodes.

In some implementations, identifying branches of the initial model includes identifying branches that result in the largest disparity across protected and control groups. Disparity can be measured in a variety of ways. For example, disparity may be measured using a difference of average predictions. Disparity may also be measured using a measure of disparate impact. In some implementations, the measure of disparate impact is adverse impact ratio (AIR). In some implementations, disparity caused by a split in the initial model is measured by disparity caused by the subtree originating from that split, thereby filtering observations seen by each split through nodes which precede it. In some implementations, disparity caused by a single split in the initial model is measured by disparity of subtree of depth 1 originating from that split, thereby isolating the split of interest rather than depending on nodes which follow from the split. Disparity may also be measured by treating two children nodes of the split as leaves, and computing scores for the two children nodes using a weighted average.

In some implementations, “segregated branches” of the initial model can be identified by considering each node as a class predictor and ranking the nodes according to how well they separate classes, as measured by the F1 score.

In some implementations, identifying “segregated branches” of the initial model includes calculating a group separation metric that indicates how well a given node separates group members based on the one or more protected classes. In some implementations, calculating the group separation metric includes computing, for each node, counts of protected and control group members that are sent down left and right branches of the node, and considering how well each branch functions as a group predictor by computing a confusion matrix-based metric by placing the counts into a 2-by-2 contingency table. In some implementations, the group separation metric is defined by the absolute value of the Matthews correlation coefficient of the contingency table.

In some implementations, identifying branches of the initial model includes ranking or ordering nodes of the initial model such that best candidates for removal are placed at the front. In some implementations, the pruning algorithm is a sequential algorithm, wherein nodes are removed in order, and model accuracy and disparate impact on unseen data are tracked for every iteration. In some implementations, the method further includes selecting a node identifying scheme based on either disparity driving or group separation, for identifying branches of the initial model to prune, based on a context of the dataset used to train or validate the initial model. In some implementations, nodes are identified for removal based on path traversals of a training dataset used to train the initial model.

In some implementations, the initial model predicts probabilistic class membership for unseen data, and has the structure of a collection of decision trees.

In some implementations, obtaining the initial model includes training the initial model. Non-limiting examples of the initial model include forest models, random forest, random stump, and gradient boost. In some implementations, the training and pruning occurs in a closed loop so as to improve accuracy.

In another aspect, a system is provided for performing any of the methods described herein.

In another aspect, a non-transitory computer readable storage medium stores one or more programs configured for execution by a computer system having a display, one or more processors, and memory. The one or more programs include instructions for performing any of the methods described herein.

The present application discloses subject-matter in correspondence with the following numbered clauses:
(A1) A method for debiasing machine learning models, the method comprising:
obtaining (i) an initial model that is a trained and tree-based machine learning model, (ii) a minimum threshold accuracy, and (iii) one or more protected classes, wherein the initial model demonstrates disparities with respect to the one or more protected classes;
identifying branches of the initial model to prune, based on the one or more protected classes; and
applying a pruning algorithm to prune the branches of the initial model to generate one or more forest models, such that (i) predictive accuracy of the one or more forest models is above the minimum threshold accuracy, and (ii) the one or more forest models are less discriminatory than the initial model.
(A2) The method as recited in clause (A1), further comprising:
obtaining a maximum number of nodes that can be removed; and
while identifying branches of the initial model to prune, avoiding selecting branches that would remove more than the maximum number of nodes.
(A3) The method as recited in any of clauses (A1)-(A2), wherein identifying branches of the initial model comprises identifying branches that result in the largest disparity across protected and control groups.
(A4) The method as recited in clause (A3), wherein disparity is measured using a difference of average predictions.
(A5) The method as recited in clause (A3), wherein disparity is measured using a measure of disparate impact.
(A6) The method as recited in clause (A5), wherein the measure of disparate impact is adverse impact ratio (AIR).
(A7) The method as recited in any of clauses (A3)-(A6), wherein disparity caused by a split in the initial model is measured by disparity caused by the subtree originating from that split, thereby filtering observations seen by each split through nodes which precede it.
(A8) The method as recited in any of clauses (A3)-(A6), wherein disparity caused by a single split in the initial model is measured by disparity of subtree of depth 1 originating from that split, thereby isolating the split of interest rather than depending on nodes which follow from the split.
(A9) The method as recited in clause (A8), wherein measuring disparity comprises treating two children nodes of the split as leaves, and computing scores for the two children nodes using a weighted average.
(A10) The method as recited in any of clauses (A1)-(A9), wherein branches of the initial model are identified by considering each node as a class predictor and ranking the nodes according to how well they separate classes, as measured by the F1 score.
(A11) The method as recited in any of clauses (A1)-(A10), wherein identifying branches of the initial model comprises calculating a group separation metric that indicates how well a given node separates group members based on the one or more protected classes.
(A12) The method as recited in clause (A11), wherein calculating the group separation metric includes:
computing, for each node, counts of protected and control group members that are sent down left and right branches of the node, when considering the node as a group predictor by looking at group identification of observations that land in the node's two children nodes corresponding to the left and right branches of the node; and
computing a confusion matrix-based metric by placing the counts into a 2-by-2 contingency table.
(A13) The method as recited in clause (A12), wherein the group separation metric is defined by absolute value of the Matthews correlation coefficient of the contingency table.
(A14) The method as recited in any of clauses (A1)-(A13), wherein identifying branches of the initial model includes ranking or ordering nodes of the initial model such that best candidates for removal are placed at the front.
(A15) The method as recited in any of clauses (A1)-(A14), wherein the pruning algorithm is a sequential algorithm, wherein nodes are removed in order, and model accuracy and disparate impact on unseen data are tracked for every iteration.
(A16) The method as recited in any of clauses (A1)-(A15), further comprising: selecting a node identifying scheme based on either disparity driving or group separation, for identifying branches of the initial model to prune, based on a context of the dataset used to train or validate the initial model.
(A17) The method as recited in any of clauses (A1)-(A16), wherein nodes are identified for removal based on path traversals of a training dataset used to train the initial model.
(A18) The method as recited in any of clauses (A1)-(A17), wherein the initial model predicts probabilistic class membership for unseen data, and has the structure of a collection of decision trees.

Various implementations of systems, methods and devices within the scope of the appended claims each have several aspects, no single one of which is solely responsible for the desirable attributes described herein. Without limiting the scope of the appended claims, some prominent features are described. After considering this discussion, and particularly after reading the section entitled “Detailed Description” one will understand how the features of various implementations are used to improve performance at the interface link while accounting for capacitance (or loading), power, and noise limitations.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIG. 1 shows the anatomy of an example tree, according to some implementations.

FIG. 2 shows steps of pruning trees in a forest, according to some implementations.

FIG. 3 illustrates bias mitigation using disparity drivers for pruning, according to some implementations.

FIGS. 4A-4D are graph plots that show results of bias mitigation for different datasets, according to some implementations.

FIG. 5 is a block diagram illustrating an example system for debiasing model(s) in accordance with some implementations.

FIG. 6 shows a flowchart of a method for debiasing machine learning models, according to some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals are used to denote like features throughout the specifications and figures.

### DETAILED DESCRIPTION

Numerous details are described herein in order to provide a thorough understanding of the example implementations illustrated in the accompanying drawings. However, the invention may be practiced without many of the specific details. And well-known methods, components, and circuits have not been described in exhaustive detail so as not to unnecessarily obscure more pertinent aspects of the implementations described herein.

### 1. Example Methodology

### Introduction and Notation

### Data and Models

Consider the binary classification problem with input data X (size N×M) and label y (size N×1), where elements of y are either 0 or 1. For each observation, let z denote protected group status (a value of 0 represents not protected and a value of 1 represents protected). Suppose further that there exists one binary protected class z. Suppose D=(X, y, z) denotes the data. The results described here extend naturally to multiple protected classes, and probabilistic class assignments rather than binary values. For example, multiple protected classes may be combined into one aggregated class. Suppose there are two protected classes, African American and Hispanic, the analysis could be performed on z=(African American OR Hispanic). As another example, for probabilistic assignments whenever a count of observation is used to determine the number of members of a class, the count is replaced with a sum across every individual of probabilistic class assignments, according to some implementations. Moreover, for disparity calculations, all averages become weighted averages with weights equal to probabilistic class assignment, according to some implementations. In the instances where probabilistic class assignments affect the computations below, any modifications induced by probabilistic class encodings are explained in the description.

Some implementations make predictions on unseen data with a model f(x)=ŷ, where f(x) takes the structure of a forest, or a collection of trees. That is, f(x) can be decomposed:

$$\\ f ( x ) = {\sum }_{i = 1}^{K} {f}_{i} ( x ) = {\sum }_{i = 1}^{K} {\hat{y}}_{i} = \hat{y}$$

where fᵢ(x) is a decision tree.

In actuality, the raw output of the model and its constituent trees measure how likely a given observation is to belong to the class y=1. This measurement is in the units of log-odds; if pᵢ is the probability of observation xᵢ belonging to class y=1, then the log-odds are:

$$\\ {o}_{i} = log ( \frac{{p}_{i}}{1 - {p}_{i}} ) .$$

In practice, model outcomes ŷᵢ are determined by imposing a cutoff \tilde{p} on probabilities, computed from a raw log-odds output.

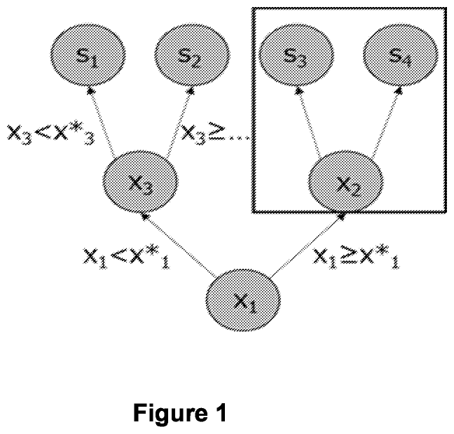

FIG. 1 shows the anatomy of an example tree. A tree is made up of nodes and branches; in the example figure, three nodes are associated with three features,
x₁, x₂, x₃, and three cutoff values, x₁⁺, x₂⁺, x₃⁺. The collection of nodes originating from an earlier node is referred to as a subtree (e.g. the subtree originated from the node x₂ is boxed in FIG. 1). Observations are funneled down branches according to whether their associated feature value is greater than or less than the cutoff Terminal nodes are called leaves, and they are associated with scores s₁, s₂, . . . , s₄, which may be in the units of log-odds. In some implementations, scores associated with terminal leaves could be in the units of counts or probabilities.

### The Regression Setting

In the case where y is a continuous variable, a forest model may also be used to make predictions on unseen data. In this setting, each leaf is again associated with a score. The scores on each leaf are in the same units as the target variable y, and predictions are made by summing predictions across trees, or taking an average across trees. For ease of description, as given the techniques are described with reference to the classification problem, but it should be understood that the methods apply directly to the regression setting as well. When necessary, any meaningful difference to the regression setting is described in the below methodology. Otherwise, the description holds in both settings.

### Disparities

In conventional systems, a tree-based model may be built without consideration of the protected attribute z. However, per the discussion in the introduction, even the exclusion of protected class status is not sufficient to guarantee that the model will treat protected group members (observations xᵢ for which z=1) the same as control group members (observations xⱼ for which z=0). Suppose the true process is y=f(x)+ε, where y is the label, f is the tree-based model, and ε is the process noise. Moreover, assume the fitted values ŷ for some data X is provided by f(X)=ŷ. Then, disparity, the differential treatment between protected and control groups, may arise from three sources in the model development. Disparities may arise as a result of the process noise ε being different between protected and control classes. This is typically referred to as omitted variable bias. Disparities can arise from differences in the data X in a few manners. If X includes explicit information about protected class status, this is sometimes considered disparate treatment and may be illegal in a regulated industry. If X consists of only predictive and facially neutral factors, then this is sometimes referred to as disparate impact. If X includes factors or the model f(x) creates factors that are closely related to the protected class status, then this is sometimes called proxy discrimination. Finally, disparities may arise from the design of the model f(x) or from the optimization process that creates the model f(x). If the model is unable to consider protected class status then it may calculate certain parameters in a manner that is less predictive or disparate to the protected class. This is sometimes called differential validity or differential bias.

For disparate impact, the mechanism behind disparity may be due to the data X being distributed differently between protected and control group members:

p(X=x|z=1)≠p(X=x|z=0),

or that the label y not being independent of group status:

p(Y=y|z=0)≠p(Y=y|z=1).

Either of these two cases are likely to result in a model f(x) which demonstrates disparate impact, typically measured by adverse impact ratio (AIR). The adverse impact ratio measures the proportion of protected group members who receive a favorable outcome against the proportion of control group members who receive a favorable outcome.

If y=1 is a favorable outcome (e.g., ‘will get a loan’), then the AIR on data (X,z) and associated outcomes ŷ is:

$$\\ A I R = \frac{\vert \{ {x}_{z = 1 , \hat{y} = 1} \} \vert}{\vert \{ {x}_{z = 1} \} \vert} / \frac{\vert \{ {x}_{z = 0 , \hat{y} = 1} \} \vert}{\vert \{ {x}_{z = 0} \} \vert} .$$

The adverse impact ratio is a measure of disparate impact in the classification setting. In a regression setting, a similar notion is the standardized mean difference (SMD), which is the difference in average outcomes between groups, normalized by the standard deviation of all outcomes.

If z is not binary and probabilistic class encodings are used, both the AIR and SMD can be modified to accommodate the change. In the adverse impact ratio, instead of counting the number of offers and non-offers received by the two groups, the user instead sums the probabilistic class weight z for those observations which receive and do not receive an offer. In the SMD, the weighted means and standard deviations may be used, with weights given by probabilistic class encodings.

Another useful notion for disparity which does not require knowing the model outcomes ŷ is disparity and can be computed directly from the raw model output. This definition is useful when no probability \tilde{p} cutoff has been specified or multiple cutoffs will be used. Disparity may be the difference of average predictions between protected and control group members. In this case, let y=1 be a favorable outcome; given data (X,z) and associated probabilistic outputs p, disparity is defined by the equation:

disparity=E(z=0)−E(z=1).

In the regression setting, the same definition applies, except the difference is taken across average model scores. In the case of probabilistic class encodings, the means become weighted by the variable z.

Given data D and a model f(x) which demonstrates a meaningful level of disparate impact on D, described below in detail are some implementations that build a less discriminatory alternative model, which still preserves the predictive accuracy necessary to meet the business purpose of the original model. Here, what constitutes a meaningful disparate impact (referred to as a ‘practically significant’ disparate impact) is a judgment dependent on business use-case. For example, the Equal Employment Opportunity Commission (EEOC) and other Federal Agencies would normally consider a selection device (test or practice or model) in the employment setting that results in an adverse impact ratio or AIR of less than 80% to have a practically significant adverse impact on protected class members. In a case in which such a practically significant adverse impact is revealed, the employer would be obligated to test whether the selection device is valid. That is, the employer must verify that the device is a valid predictor of performance on the job, and is not biased against the protected class. If the device is not valid, then it is considered illegally discriminatory. Moreover, even if the device is valid, if another selection device can be shown to be similarly valid and have less disparate impact, then the use of the first selection device rather than the alternative selection device would be considered to be illegally discriminatory. Regulators in the fair lending space often require credit lenders to adopt an internal policy defining what is “practically significant,” and further requiring them to search for a similarly valid algorithm with less disparate impact in cases in which they discover that their valid operating algorithm has a practically significant disparate impact.

The following two sections describe two methodologies for building a less discriminatory alternative model and reducing the risk of proxy bias, based on pruning. Conventional systems that find fair machine learning models (e.g., fair forests) do not use pruning as a ‘post-processing’ model debiasing methodology. The pruning methodology described herein can be integrated with the widely-used tree-based model libraries, although each uses different methods and data structures to store the underlying tree structure. Although there are many node identification schemes within the two classes identified as described above, this is easily parameterized based on user input. Furthermore, with the techniques below, the user can configure the number of nodes to remove. In this way, the methodology is adapted to a particular use case.

### Pruning

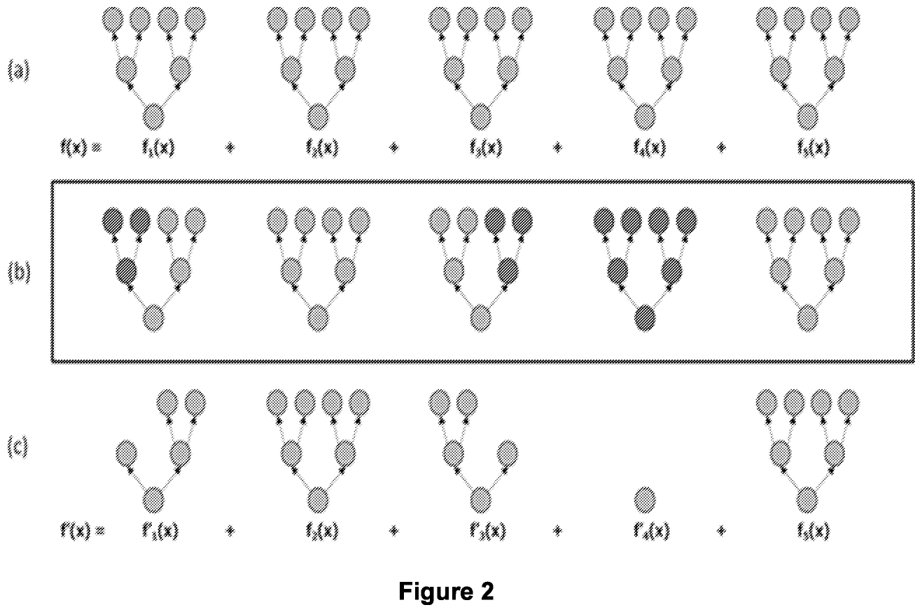

Tree pruning is a well-understood method of processing tree-based models, usually with the goal of improving generalizability (the ability of the model to make accurate predictions on unseen data). Pruning involves creating new leaves in place of branches of a tree. The score assigned to the new leaf is the weighted average of scores of all leaves which were removed by the prune, with weights proportional to the number of samples which landed in each leaf in the training dataset. FIG. 2 shows the two steps of pruning trees in a forest, according to some implementations. Given a forest as shown in (a), first branches (or whole trees) are identified as candidates for pruning as shown in (b). Then, new leaves are generated by cutting the trees at the identified originating node of the branches as shown in (c). The new leaves have scores equal to a weighted average of the scores of the removed leaves.

Two classes of methods for identifying branches to prune are described herein, according to some implementations. Both techniques utilize the protected attribute z, and according to some implementations result in new forest models which are less discriminatory than the original model, while preserving predictive accuracy.

### Example Method Using Disparity Drivers

Some implementations identify those branches which result in the largest disparity across groups. Some implementations use a definition of disparity that is described above (the difference of average predictions). Some implementations use a measure of disparate impact, such as the adverse impact ratio.

In order to measure how much disparity is caused by a split, some implementations measure the disparity caused by the subtree originating from that split. Since the observations which will be seen by each split are filtered through the nodes which precede it, it makes sense to measure the disparity on only that dataset.

Some implementations use an alternative notion of disparity caused by a single node, and consider the disparity of the branches of depth 1 originating from that node. This technique has the advantage of isolating the node of interest, rather than depending on the nodes which follow from the split.

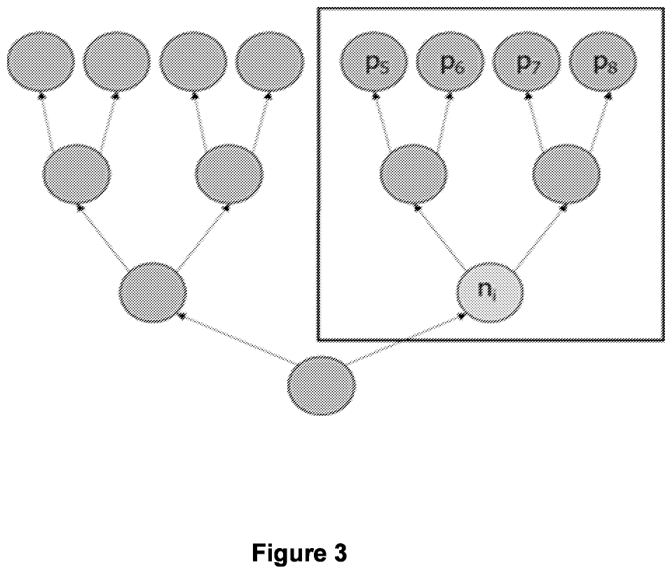

FIG. 3 illustrates the method described above, according to some implementations. In order to calculate the disparity of the node n₁, highlighted in yellow, some implementations consider the terminal leaves of the subtree originating from n₁. These leaves are associated with probabilities p₅, . . . , p₈, as well as group counts Nⱼ^{protected}, Nⱼ^{control}j∈{5,6,7,8}, found by tracing a dataset through the forest. Table 1 below shows an example of the quantities necessary to compute the node's disparity. The disparity of node nᵢ is equal to a difference of weighted averages of scores. In this case:

$$\\ {disparity}_{{n}_{i}} = \frac{1}{180} ( 0.1 * 20 + 0.15 * 100 + 0.01 * 10 + 0.05 * 50 ) - \frac{1}{330} ( 0.1 * 20 + 0.15 * 10 + 0.01 * 200 + 0.05 * 100 ) = 0.109 - 0.032 = 0.077$$

TABLE 1

| Leaf | Score (probability) | Number of protected | Number of control |
|---|---|---|---|
| 5 | 0.1 | 20 | 20 |
| 6 | 0.15 | 100 | 10 |
| 7 | 0.01 | 10 | 200 |
| 8 | 0.05 | 50 | 100 |

### Example Method Using Group Separators

Some implementations measure how well a given node separates group members z=0, 1. For this, a variety of techniques are used. For example, some implementations consider the node as a group predictor by looking at the group identification of the observations that land in the two children nodes. In other words, some implementations compute, for each node, counts of the protected and control group members that are sent down the left and right branches. In some implementations, these counts are placed in a 2×2 contingency table, and various confusion matrix-based metrics are computed and used as a measure of group separation. This node identification method is agnostic to the classification or regression setting. In the case of probabilistic class encodings, instead of counting protected and control group members being sent down the branches, the methodology allows for the nonbinary protected class z to instead be summed within the observations that are sent down the two branches.

For example, some implementations use a group separation metric defined by the absolute value of the Matthews correlation coefficient of such a contingency table. The absolute value serves to handle the symmetry of the problem, since it does not matter if the left branch or the right branch are conceptually ‘predicting’ protected group status.

Table 2 below provides an example of the calculation of the group separation metric defined above on 7 nodes for a binary tree of depth 3. Counts of protected and control observations sent down left and right branches can be considered as occupying a 2×2 contingency table, where ‘branch’ is predicting ‘protected’. The absolute value of the Matthews correlation coefficient (MCC) is one such ‘group separator’ metric that can be calculated based on these values.

TABLE 2

| Node | protected | protected | control | control | |
|---|---|---|---|---|---|
| number | left (TP) | right (FN) | left (FP) | right (TN) | \|MCC\| |
| 1 | 100 | 100 | 100 | 100 | 0 |
| 2 | 100 | 0 | 0 | 100 | 1 |
| 3 | 95 | 5 | 5 | 95 | 0.9 |
| 4 | 60 | 40 | 0 | 0 | NA |
| 5 | 0 | 0 | 30 | 70 | NA |
| 6 | 73 | 22 | 2 | 3 | 0.185 |
| 7 | 4 | 1 | 6 | 89 | 0.572 |

According to the implementation provided above, the example nodes in Table 2 would be pruned in the order (2, 3, 7, 6, 1), which is the order induced by sorting on |MCC|, the absolute value of the Matthews correlation coefficient. Note that nodes 4 and 5 do not have |MCCI values because they are already entirely separated, having no control or protected observations respectively. This is due to their parent node, node 2, completely separating the protected and control class observations. Perfect separation in this manner leads to a maximal |MCCI value of 1 and thus will be pruned first along with its children nodes 4 and 5.

### Sequential Node Removal

An advantage of the two example node-identification methods described above is that the examples admit a ranking of nodes. That is, the list of identified nodes can be ordered such that the best candidates for removal are placed at the front. This suggests a sequential pruning algorithm, wherein nodes are removed in order, and model performance and disparate impact on unseen data is tracked for every iteration. Instead of tracking model performance, the user may instead track another quantity of interest during pruning. For example, removal of group separating nodes may be used to mitigate the risk of the forest model forming proxies for protected group status, which is illegal in some regulatory settings. Example Algorithm 1 shown below outlines the process which yields less discriminatory alternative models that still meet a minimum threshold of business viability (e.g., accuracy).

Algorithm 1

```
Given candidate nodes [n₁, n₂, ... , n_{N}], forest model f(x), and quality drop
threshold epsilon.
Compute accuracy₀ and disparate impact₀ for forest model f.
for i = 1, N:
  Build alternative model fᵢ′(x) by pruning nodes 1 ... , i
  Compute disparate impact and accuracy
  if accuracy < accuracy₀ − epsilon or disparate impact >
disparate impact₀
    return fᵢ₋₁′(x)
return f_{N}′(x)
```

### 2. Experiments

### Data Generation

In order to evaluate the efficacy of the two classes of pruning methods, an experiment was conducted to first simulate two simple datasets. The datasets are based on the data generating process described by Scott Lundberg in ‘Explaining Quantitative Measures of Fairness,’ with some modifications.

The datasets have a binary label y=default, which should be interpreted as a loan which has gone bad. There are five features: reported income, job history, number of credit inquiries, number of late payments, and brand X purchase score. The likelihood that a given loan will go bad depends on four underlying causal factors: income stability, income amount, spending restraint, and consistency. The first four features depend on these four underlying causal factors via complicated functions. The fifth feature, brand X purchase score, is not causally linked to default rate, but it has a positive correlation with protected attribute z, and therefore allows the model to ‘learn’ an observation's group status with a high degree of uncertainty.

The first dataset is simplest. It is designed to demonstrate a realistic degree of disparate impact, but no further complications are introduced than those described below. This dataset is referred to as simu_simple.

In order to generate data that will produce models that have a reasonable amount of disparate impact, introduce a group difference in the causal factor income which results in an average group difference in both true default rate as well as the values of feature reported income.

E(z=1)≈55000, and E(z=0)≈66000.

On top of this group difference, introduce a blanket group difference in true default rate equal to approximately 15%. This can be thought of as a general ‘historical discrimination’ factor, which is not directly accounted for in the four causal factors.

The second dataset, which is referred to as simu_complex, includes the same kinds of group differences as simu_simple (income difference of ˜30000, default rate difference of 8%). Additionally, the dataset displays the following phenomena:
i. Protected group members have slightly shorter job histories, on average.
ii. Protected group members underreport their income slightly.
iii. Protected group members are slightly less likely to make late payments.
iv. The correlation between proxy feature ‘brand X purchase score’ and the protected attribute is doubled in strength.

Each dataset contains N=40000 observations, which are broken into training (75%) and validation (25%).

### Model Training and Evaluation

After the data is split into training and validation sets, an XGBoost classifier model is trained with a log loss objective function. XGBoost is a widely used library for building tree-based gradient boosted forests.

Some implementations use the XGBoost library because it results in high-performing forest models without the need for extensive hyperparameter tuning. Crucially, the algorithms described herein apply to any tree-based model.

On dataset simu_simple, an XGBoost classifier model with tree depth 3 is trained using early stopping on validation data. Early stopping results in a forest with 108 trees. The model has an AUC score of 0.931 and 0.929 on training and validation data, respectively. The model shows meaningful disparities, with adverse impact ratios of 0.857 and 0.868 on training and validation data.

On the dataset simu_complex, the tree depth is increased to 5 and all other hyperparameters are left the same. Early stopping results in a forest with 58 trees. The model has an AUC score of 0.905 and 0.898 on training and validation data, respectively. The model has an adverse impact ratio of 0.859 on validation data.

### Results

This section describes results for one pruning method within each of the two classes of methods described above. Experiments suggest that while the two classes result in meaningfully different collections of nodes identified as candidates for pruning, there is not meaningful variability within a class of methods.

The first collection of nodes is identified based on the disparity caused by the sub-tree of depth 1 emanating from the node. That is, the two children nodes are treated as leaves, and their scores are computed by using a weighted average, if necessary. These nodes are an example of ‘Disparity Drivers.’

The second collection of nodes is identified by considering each node as a class predictor rather than default predictor and ranking the nodes according to how well they separate classes, as measured by the F1 score. These nodes are ‘Group Separators.’

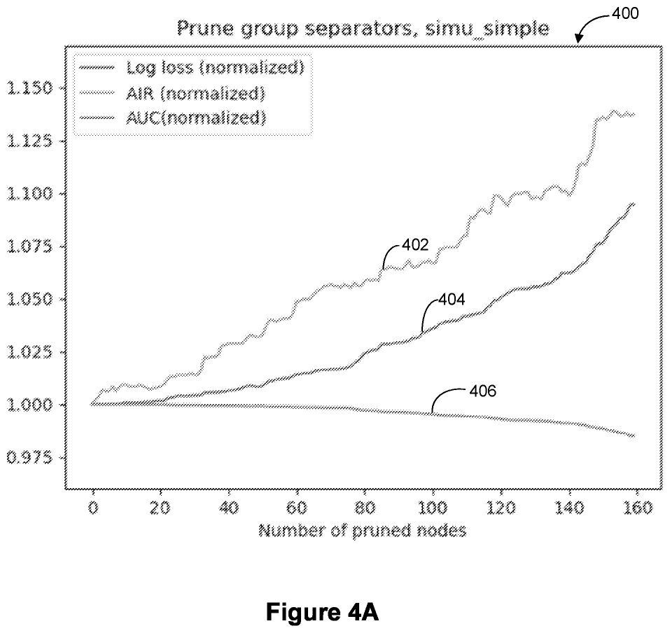

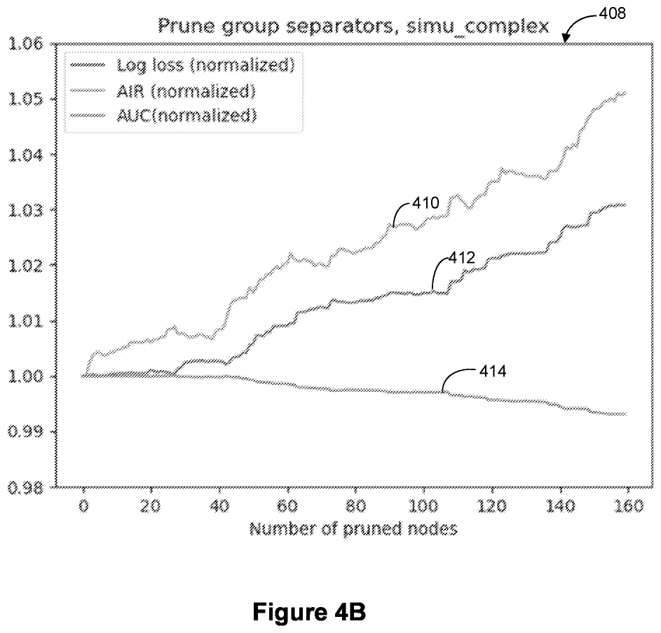

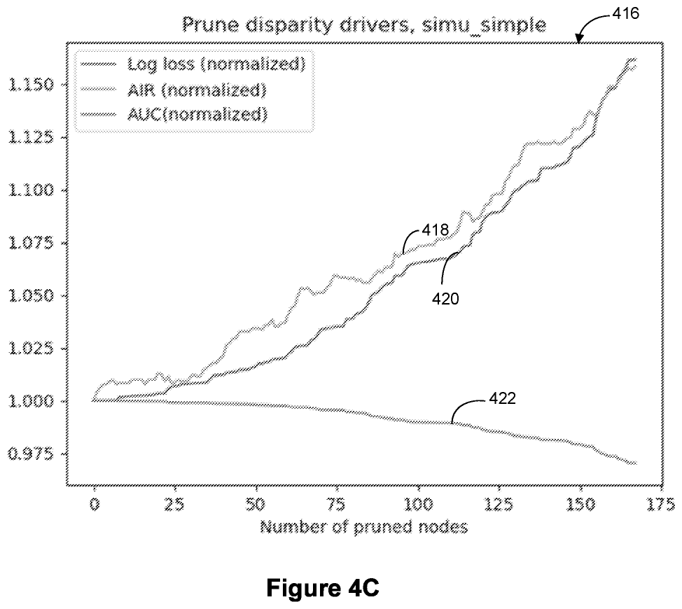

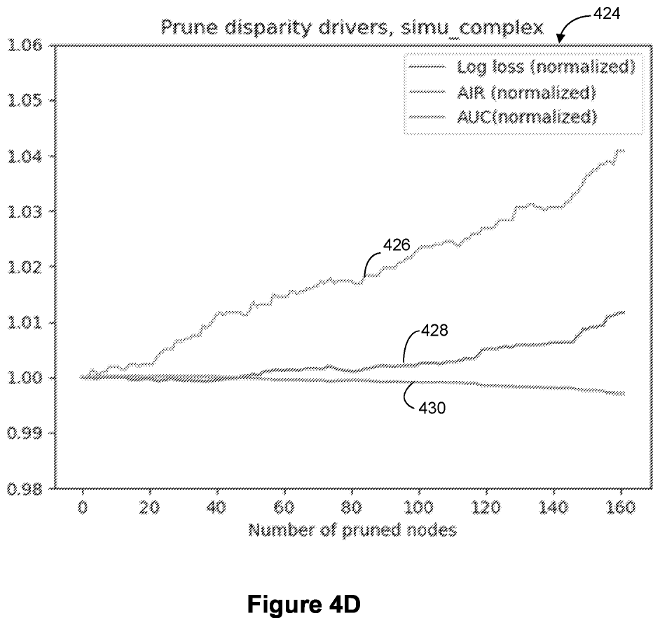

Results for datasets simu_simple and simu_complex are shown in FIGS. 4A-4D, according to some implementations. FIGS. 4A and 4B show graph plots 400 and 408, respectively, that correspond to results when using group separators for the datasets simu_simple and simu_complex, respectively. FIGS. 4C and 4D show graph plots 416 and 424, respectively, that correspond to results when using disparity drivers for the datasets simu_simple and simu_complex, respectively. Plotted are lines showing the adverse impact ratio (AIR) (lines 402, 410, 418 and 416), log loss (lines 404, 412, 420 and 428), and AUC (lines 406, 414, 422 and 430), of the pruned forest models as nodes are sequentially removed. The true number of pruned nodes varies across the four plots, since the list of nodes identified for pruning may contain nodes that lie on the same path. In this case, pruning the downstream node is unnecessary, as it will be removed when its parent/grandparent node is removed. The metrics in FIGS. 4A-4D are all normalized to their values for the unmodified model.

FIGS. 4A-4D shows the degree to which the fair pruning methodology reduces disparities while preserving model accuracy, according to some implementations. First, note the unintuitive result that removing the ‘disparity drivers’ nodes can actually make disparity worse for the protected group, as evidenced by the AIR momentarily decreasing as nodes are removed. This can be explained by the fact that nodes were identified for removal based on the path traversals of the training dataset, whereas metrics are reported on the validation dataset.

On the simu_simple data, both methods achieve demographic parity (AIR=1.006 and 0.987 for disparity driving nodes and group separating nodes, respectively). For simu_complex, the methods raise the AIR from 0.859 to 0.902 for disparity driving nodes, and to 0.894 for group separating nodes.

Interestingly, removing the nodes associated with group separation appears to result in a more favorable fairness/accuracy tradeoff than does removing the disparity-driving nodes on the simu_simple data. The opposite holds true for simu_complex, with the removal of disparity-driving nodes resulting in a greater than 4% increase in AIR for a less than 2% increase in log loss. These results suggest that the optimal node identification scheme is likely context-dependent.

For example, the user may analyze their data in advance of pruning in order to identify the optimal node identification scheme to use. In another implementation, a dynamic node identification scheme may be used. The sequence of nodes which are removed is made up of a combination of many types of group separators or disparity driving nodes.

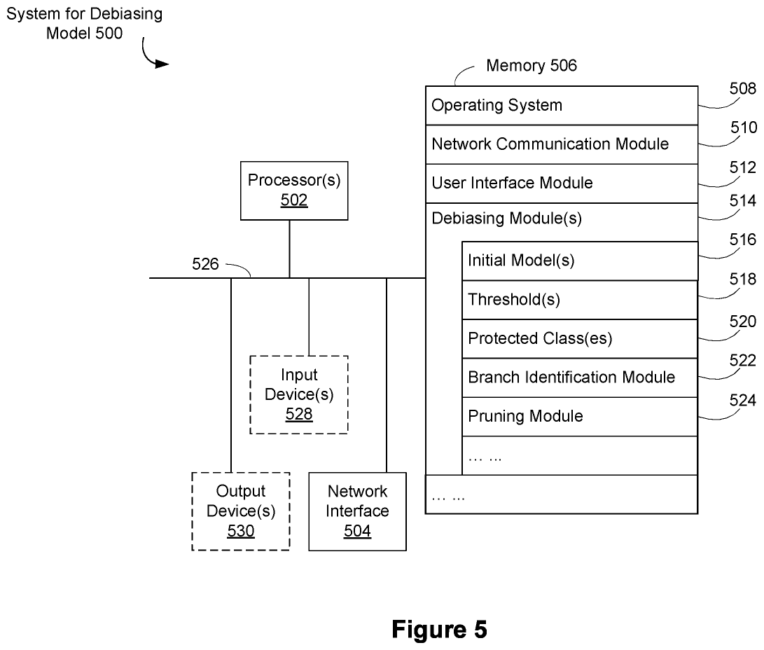

FIG. 5 is a block diagram illustrating an example system 500 for debiasing model(s) in accordance with some implementations. The system 500 includes one or more processors 502 (e.g., CPUs, GPUs, ASICs), one or more network interfaces 504, memory 506, and one or more communication buses 526 for interconnecting these components (sometimes called a chipset). The system 500 may include one or more input devices 528 that facilitate user input, such as a keyboard, a mouse, a voice-command input unit or microphone, a touch screen display, a touch-sensitive input pad, a gesture capturing camera, or other input buttons or controls. The system 500 may also include one or more output devices 530 that enable presentation of user interfaces and display content, including one or more displays.

The memory 506 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 506, optionally, includes one or more storage devices remotely located from one or more processing units 502. The memory 506, or alternatively the non-volatile memory within the memory 506, includes a non-transitory computer readable storage medium. In some implementations, the memory 506, or the non-transitory computer readable storage medium of the memory 506, stores the following programs, modules, and data structures, or a subset or superset thereof:
Operating system 508 including procedures for handling various basic system services and for performing hardware dependent tasks;
Network communication module 510 for connecting the system 500 to other devices (e.g., various servers in the system 500, client devices, cast devices, electronic devices, and smart home devices) via one or more network interfaces 504 (wired or wireless) and one or more networks, such as the Internet, other wide area networks, local area networks, metropolitan area networks, and so on;
Optionally, a user interface module 512 for enabling presentation of information (e.g., a graphical user interface for presenting application(s)) at a client device or using the output device(s) 530; and
Debiasing module(s) 514, including:
   Initial model(s) 516 that obtain machine learning models (e.g., trained and tree-based machine learning model(s). In some implementations, this also includes training the machine learning models;
   Threshold(s) 518 that include a minimum threshold accuracy;
   Protected class(es) 520. The initial model demonstrates disparities with respect to the one or more protected classes;
   Branch identification module 522 that identifies branches of the initial model to prune, based on the one or more protected classes; and
   Pruning module 524 that applies a pruning algorithm to prune the branches of the initial model to generate one or more forest models, such that (i) predictive accuracy of the one or more forest models is above the minimum threshold accuracy, and (ii) the one or more forest models are less discriminatory than the initial model.

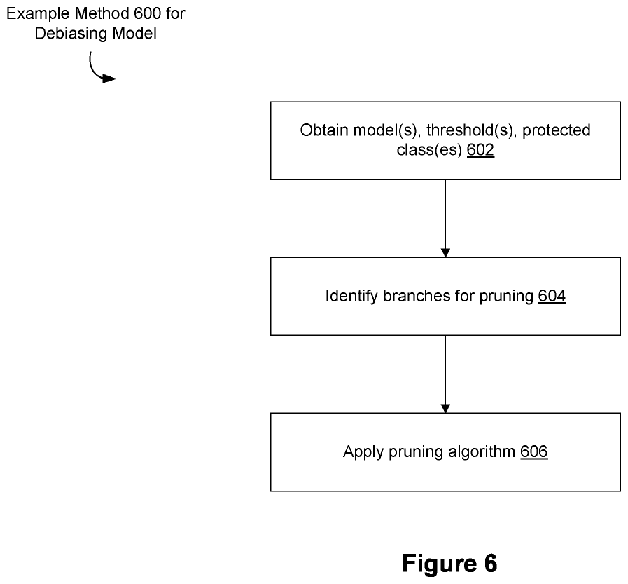

Operations of component(s) and/or module(s) of the system 500 are further described below in reference to FIG. 6, according to some implementations.

FIG. 6 shows a flowchart of a method 600 for debiasing machine learning models, according to some implementations. The method is performed at a computing system (e.g., the system 500) having one or more processors (e.g., the processors 502) and memory (e.g., the memory 506) storing one or more programs configured for execution by the one or more processors. The method 600 includes obtaining (602) model(s) 516, threshold(s) 518, and protected class(es) 520. This may include obtaining (i) an initial model that is a trained and tree-based machine learning model, (ii) a minimum threshold accuracy, and (iii) one or more protected classes. The initial model demonstrates disparities with respect to the one or more protected classes. In some implementations, the initial model predicts probabilistic class membership for unseen data, and has the structure of a collection of decision trees.

The method 600 also includes identifying (604) branches (e.g., using the branch identification module 522) of the initial model to prune, based on the one or more protected classes. In some implementations, identifying branches of the initial model includes identifying branches that result in the largest disparity across protected and control groups. In some implementations, disparity is measured using a difference of average predictions. In some implementations, disparity is measured using a measure of disparate impact. In some implementations, the measure of disparate impact is adverse impact ratio (AIR). In some implementations, disparity caused by a split in the initial model is measured by disparity caused by the subtree originating from that split, thereby filtering observations seen by each split through nodes which precede it. In some implementations, disparity caused by a single split in the initial model is measured by disparity of subtree of depth 1 originating from that split, thereby isolating the split of interest rather than depending on nodes which follow from the split. In some implementations, measuring disparity includes treating two children nodes of the split as leaves, and computing scores for the two children nodes using a weighted average. In some implementations, branches of the initial model are identified by considering each node as a class predictor and ranking the nodes according to how well they separate classes, as measured by the F1 score. In some implementations, identifying branches of the initial model includes calculating a group separation metric that indicates how well a given node separates group members based on the one or more protected classes. In some implementations, calculating the group separation metric includes: computing, for each node, counts of protected and control group members that are sent down left and right branches of the node, when considering the node as a group predictor by looking at group identification of observations that land in the node's two children nodes corresponding to the left and right branches of the node; and computing a confusion matrix-based metric by placing the counts into a 2-by-2 contingency table. In some implementations, the group separation metric is defined by absolute value of the Matthews correlation coefficient of the contingency table. In some implementations, identifying branches of the initial model includes ranking or ordering nodes of the initial model such that best candidates for removal are placed at the front. In some implementations, the method 600 further includes: obtaining a maximum number of nodes that can be removed; and while identifying branches of the initial model to prune, avoiding selecting branches that would remove more than the maximum number of nodes. In some implementations, the method further includes selecting anode identifying scheme based on either disparity driving or group separation, for identifying branches of the initial model to prune, based on a context of the dataset used to train or validate the initial model.

The method 600 also includes applying (606) a pruning algorithm (e.g., using the pruning module 524) to prune the branches of the initial model to generate one or more forest models, such that (i) predictive accuracy of the one or more forest models is above the minimum threshold accuracy, and (ii) the one or more forest models are less discriminatory than the initial model. In some implementations, the pruning algorithm is a sequential algorithm. Nodes are removed in order, and model accuracy and disparate impact on unseen data are tracked for every iteration. In some implementations, nodes are identified for removal based on path traversals of a training dataset used to train the initial model.

In this way, processing techniques are used for bias mitigation for tree-based machine learning models. In the example pruning methodology described above, nodes are identified for removal by leveraging access to a protected attribute. Two example classes of node-identification schemes that use disparity drivers and group separators, respectively, are also described, according to some implementations. In either case, the removal of nodes based on these identification schemes has been shown to produce fairer alternative models with preservation of predictive quality. One advantage of the algorithm described in this document is the ability to select where on the fairness/accuracy tradeoff the alternative model lands, depending on the number of nodes removed. This is similar to the role a regularization hyperparameter plays in some in-processing debiasing techniques, and here the connection between amount of pruning and fairness/accuracy is even more explicit.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for debiasing machine learning models, the method comprising:
obtaining (i) an initial model that is a trained and tree-based machine learning model, (ii) a minimum threshold accuracy, and (iii) one or more protected classes, wherein the initial model demonstrates disparities with respect to the one or more protected classes;
identifying branches of the initial model to prune, based on the one or more protected classes; and
applying a pruning algorithm to prune the branches of the initial model to generate one or more forest models, such that (i) predictive accuracy of the one or more forest models is above the minimum threshold accuracy, and (ii) the one or more forest models are less discriminatory than the initial model.

2. The method of claim 1, further comprising:
obtaining a maximum number of nodes that can be removed; and
while identifying branches of the initial model to prune, avoiding selecting branches that would remove more than the maximum number of nodes.

3. The method of claim 1, wherein identifying branches of the initial model comprises identifying branches that result in the largest disparity across protected and control groups.

4. The method of claim 3, wherein disparity is measured using a difference of average predictions.

5. The method of claim 3, wherein disparity is measured using a measure of disparate impact.

6. The method of claim 5, wherein the measure of disparate impact is adverse impact ratio (AIR).

7. The method of claim 3, wherein disparity caused by a split in the initial model is measured by disparity caused by the subtree originating from that split, thereby filtering observations seen by each split through nodes which precede it.

8. The method of claim 3, wherein disparity caused by a single split in the initial model is measured by disparity of subtree of depth 1 originating from that split, thereby isolating the split of interest rather than depending on nodes which follow from the split.

9. The method of claim 8, wherein measuring disparity comprises treating two children nodes of the split as leaves, and computing scores for the two children nodes using a weighted average.

10. The method of claim 1, wherein branches of the initial model are identified by considering each node as a class predictor and ranking the nodes according to how well they separate classes, as measured by the F1 score.

11. The method of claim 1, wherein identifying branches of the initial model comprises calculating a group separation metric that indicates how well a given node separates group members based on the one or more protected classes.

12. The method of claim 11, wherein calculating the group separation metric includes:
computing, for each node, counts of protected and control group members that are sent down left and right branches of the node, when considering the node as a group predictor by looking at group identification of observations that land in the node's two children nodes corresponding to the left and right branches of the node; and
computing a confusion matrix-based metric by placing the counts into a 2-by-2 contingency table.

13. The method of claim 12, wherein the group separation metric is defined by absolute value of the Matthews correlation coefficient of the contingency table.

14. The method of claim 1, wherein identifying branches of the initial model includes ranking or ordering nodes of the initial model such that best candidates for removal are placed at the front.

15. The method of claim 1, wherein the pruning algorithm is a sequential algorithm, wherein nodes are removed in order, and model accuracy and disparate impact on unseen data are tracked for every iteration.

16. The method of claim 1, further comprising:
selecting a node identifying scheme based on either disparity driving or group separation, for identifying branches of the initial model to prune, based on a context of the dataset used to train or validate the initial model.

17. The method of claim 1, wherein nodes are identified for removal based on path traversals of a training dataset used to train the initial model.

18. The method of claim 1, wherein the initial model predicts probabilistic class membership for unseen data, and has the structure of a collection of decision trees.

19. A computer system for debiasing machine learning models, comprising:
one or more processors; and
memory;
wherein the memory stores one or more programs configured for execution by the one or more processors, and the one or more programs comprising instructions for:
obtaining (i) an initial model that is a trained and tree-based machine learning model, (ii) a minimum threshold accuracy, and (iii) one or more protected classes, wherein the initial model demonstrates disparities with respect to the one or more protected classes;
identifying branches of the initial model to prune, based on the one or more protected classes; and
applying a pruning algorithm to prune the branches of the initial model to generate one or more forest models, such that (i) predictive accuracy of the one or more forest models is above the minimum threshold accuracy, and (ii) the one or more forest models are less discriminatory than the initial model.

20. A non-transitory computer readable storage medium storing one or more programs configured for execution by a computer system having a display, one or more processors, and memory, the one or more programs comprising instructions for:
obtaining (i) an initial model that is a trained and tree-based machine learning model, (ii) a minimum threshold accuracy, and (iii) one or more protected classes, wherein the initial model demonstrates disparities with respect to the one or more protected classes;
identifying branches of the initial model to prune, based on the one or more protected classes; and
applying a pruning algorithm to prune the branches of the initial model to generate one or more forest models, such that (i) predictive accuracy of the one or more forest models is above the minimum threshold accuracy, and (ii) the one or more forest models are less discriminatory than the initial model.
